(19) United States
(12) Patent Application Publication
(10) Pub. No.: US 2026/0323649 A1
(43) Pub. Date: Oct. 15, 2026

(54) UNUSED TIME OCCASION UPLINK CONTROL INFORMATION INDICATIONS

(71) Applicant: QUALCOMM Incorporated, San Diego, CA (US)

(72) Inventors: Fang YUAN, Beijing (CN); Diana MAAMARI, San Diego, CA (US); Yan ZHOU, San Diego, CA (US)

(21) Appl. No.: 19/482,130

(22) PCT Filed: Jun. 29, 2023
(86) PCT No.: PCT/CN2023/103720

§ 371 Date: Nov. 6, 2025

(51) Int. Cl. H04W 72/21; H04W 72/0446

(52) U.S. Cl. CPC H04W 72/21; H04W 72/0446

(57) ABSTRACT

Various aspects of the present disclosure generally relate to wireless communication. In some aspects, a user equipment (UE) may receive configuration information indicative of a plurality of configured grant (CG) configurations associated with at least one unused time occasion (UTO). The UE may transmit a UTO-uplink control information (UCI) (UTO-UCI) indication comprising at least one UTO parameter indicative of at least one skipped CG occasion associated with at least one CG configuration of the plurality of CG configurations. Numerous other aspects are described.

### FIELD OF THE DISCLOSURE

Aspects of the present disclosure generally relate to wireless communication and to techniques and apparatuses for unused time occasion uplink control information indications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include one or more memories and one or more processors coupled to the one or more memories. The one or more processors may be configured to receive configuration information indicative of a plurality of configured grant (CG) configurations associated with at least one unused time occasion (UTO). The one or more processors may be configured to transmit a UTO-uplink control information (UCI) (UTO-UCI) indication comprising at least one UTO parameter indicative of at least one skipped CG occasion associated with at least one CG configuration of the plurality of CG configurations.

Some aspects described herein relate to a network node for wireless communication. The network node may include one or more memories and one or more processors coupled to the one or more memories. The one or more processors may be configured to transmit configuration information indicative of a plurality of CG configurations associated with at least one UTO. The one or more processors may be configured to receive a UTO-UCI indication comprising at least one UTO parameter indicative of at least one skipped CG occasion associated with at least one CG configuration of the plurality of CG configurations.

Some aspects described herein relate to a method of wireless communication performed by a UE. The method may include receiving configuration information indicative of a plurality of CG configurations associated with at least one UTO. The method may include transmitting a UTO-UCI indication comprising at least one UTO parameter indicative of at least one skipped CG occasion associated with at least one CG configuration of the plurality of CG configurations.

Some aspects described herein relate to a method of wireless communication performed by a network node. The method may include transmitting configuration information indicative of a plurality of CG configurations associated with at least one UTO. The method may include receiving a UTO-UCI indication comprising at least one UTO parameter indicative of at least one skipped CG occasion associated with at least one CG configuration of the plurality of CG configurations.

Some aspects described herein relate to a non-transitory computer-readable medium that stores a set of instructions for wireless communication by a UE. The set of instructions, when executed by one or more processors of the UE, may cause the UE to receive configuration information indicative of a plurality of CG configurations associated with at least one UTO. The set of instructions, when executed by one or more processors of the UE, may cause the UE to transmit a UTO-UCI indication comprising at least one UTO parameter indicative of at least one skipped CG occasion associated with at least one CG configuration of the plurality of CG configurations.

Some aspects described herein relate to a non-transitory computer-readable medium that stores a set of instructions for wireless communication by a network node. The set of instructions, when executed by one or more processors of the network node, may cause the network node to transmit configuration information indicative of a plurality of CG configurations associated with at least one UTO. The set of instructions, when executed by one or more processors of the network node, may cause the network node to receive a UTO-UCI indication comprising at least one UTO parameter indicative of at least one skipped CG occasion associated with at least one CG configuration of the plurality of CG configurations.

Some aspects described herein relate to an apparatus for wireless communication. The apparatus may include means for receiving configuration information indicative of a plurality of CG configurations associated with at least one UTO. The apparatus may include means for transmitting a UTO-UCI indication comprising at least one UTO parameter indicative of at least one skipped CG occasion associated with at least one CG configuration of the plurality of CG configurations.

Some aspects described herein relate to an apparatus for wireless communication. The apparatus may include means for transmitting configuration information indicative of a plurality of CG configurations associated with at least one UTO. The apparatus may include means for receiving a UTO-UCI indication comprising at least one UTO parameter indicative of at least one skipped CG occasion associated with at least one CG configuration of the plurality of CG configurations.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5A is a diagram illustrating an example associated with unused time occasion (UTO) uplink control information (UTO-UCI) indications, in accordance with the present disclosure.

FIG. 5B is a diagram illustrating an example associated with floating window periodicities for UTO-UCI indications, according to the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

In some cases, a user equipment (UE) may be configured with one or more uplink configured grant (CG) configurations. In some cases, a UE may skip one or more CG occasions. In some cases, the UE may multiplex uplink control information (UCI) in a CG physical uplink shared channel (PUSCH) occasion. In some cases, the UE may transmit an indication (a “skipping indication”) associated with one or more skipped CG PUCSH occasions. In some cases, multiple CG PUSCH transmission occasions may be scheduled in a period of a single CG PUSCH configuration. The UCI may be transmitted in a time occasion for indicating unused time occasion (UTO) and may be referred to as UTO-UCI. Indication of UTO-UCI by CG PUSCHs associated to a CG configuration may be enabled by configuration of a radio resource control (RRC) parameter. In some aspects, to facilitate multiple CG configuration scheduling, a UTO period parameter may be configured to indicate a length of a UTO period. In some aspects, the UTO period may be any value of time. In some aspects, the UTO period may have a value associated with one or more CG periodicities (e.g., specified by an integer value). In some cases, a UTO offset parameter may indicate a UTO offset. In some cases, the UTO offset may be configured and/or specified by a wireless communication standard. In some cases, a transmitted CG PUSCH can carry UTO-UCI that is applicable to the valid CG PUSCH time occasions that are confined within the UTO period starting with a UTO offset from the end of the transmitted CG PUSCH. However, without indication of the UTO parameters, a network node may not be able to receive communications during UTOs.

Some aspects of the techniques described herein provide for transmitting UTO-UCI indications. The UTO-UCI indications may include at least one UTO parameter indicative of at least one skipped CG occasion associated with at least one CG configuration of a plurality of CG configurations. In this way, some aspects may facilitate reception, at the network, of UTO-UCI, thereby positively impacting network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

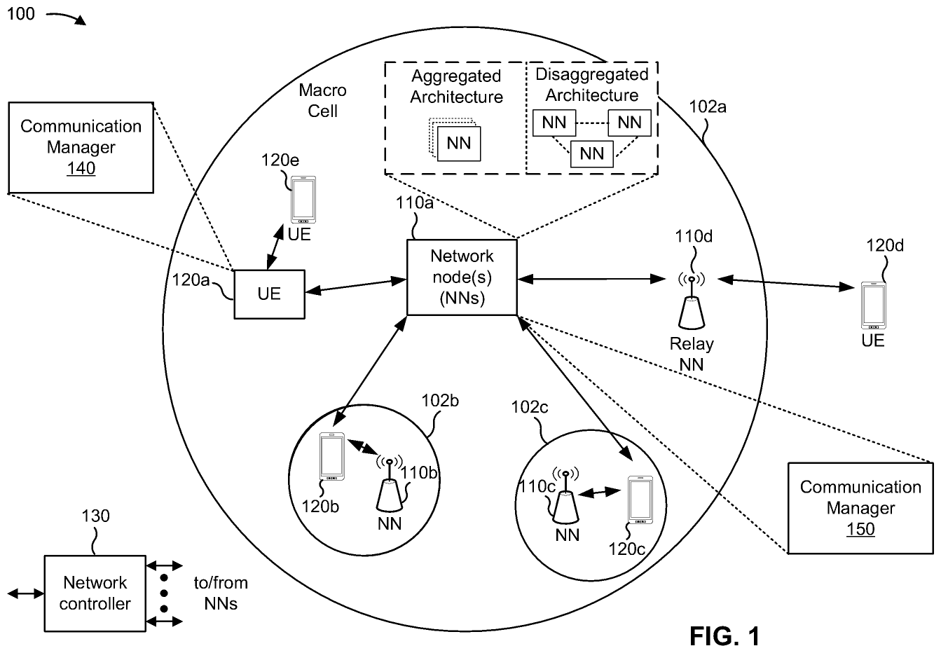

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive configuration information indicative of a plurality of CG configurations associated with at least one UTO; and transmit a UTO-UCI indication comprising at least one UTO parameter indicative of at least one skipped CG occasion associated with at least one CG configuration of the plurality of CG configurations. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit configuration information indicative of a plurality of CG configurations associated with at least one UTO; and receive a UTO-UCI indication comprising at least one UTO parameter indicative of at least one skipped CG occasion associated with at least one CG configuration of the plurality of CG configurations. Additionally, or alternatively, the communication manager 150 may perform one or more other operations described herein.

As indicated above, FIG. 1 is provided as an example. Other examples may differ from what is described with regard to FIG. 1.

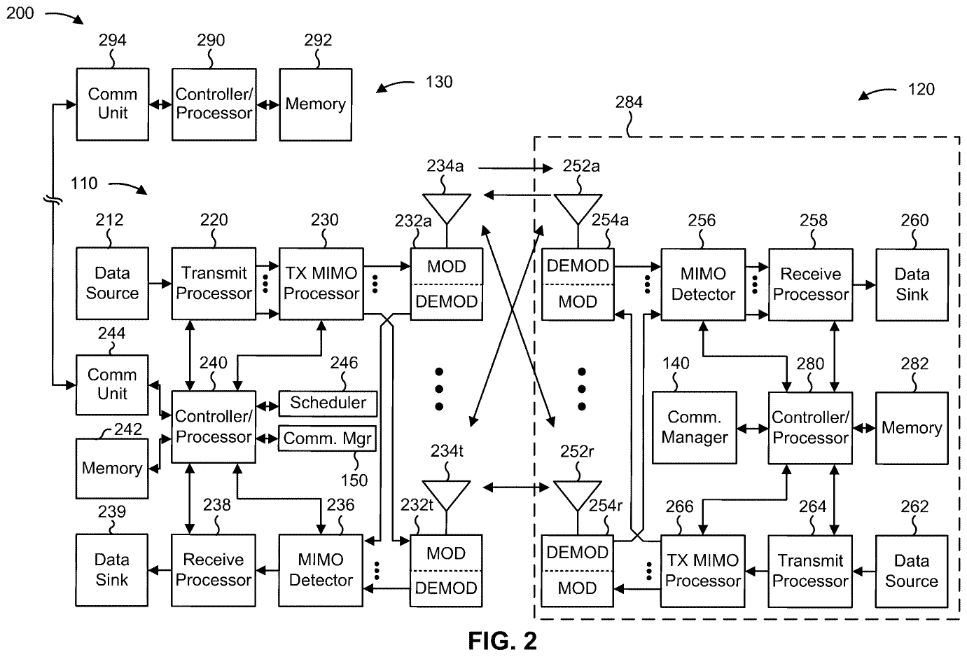

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

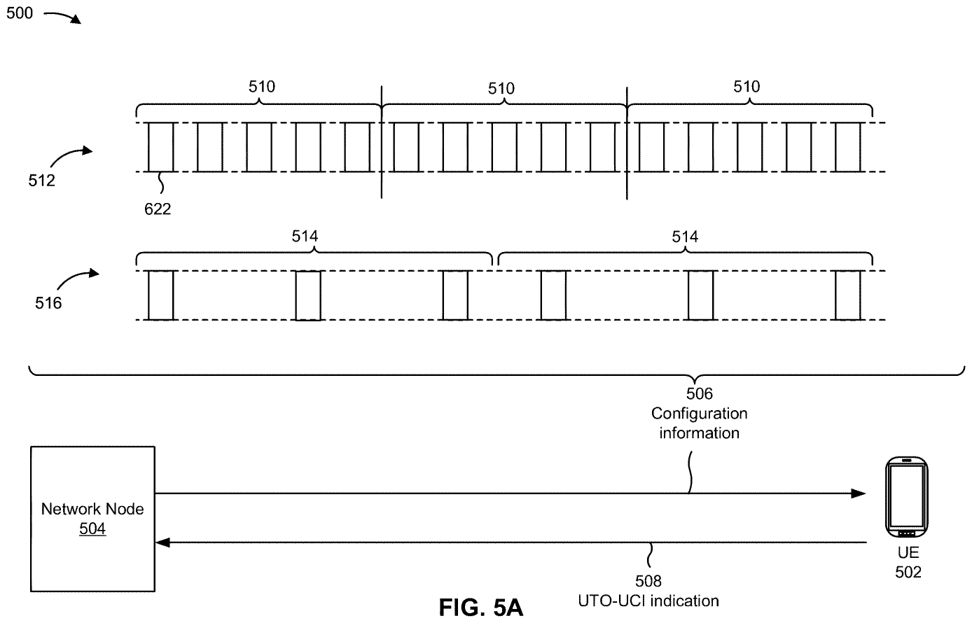

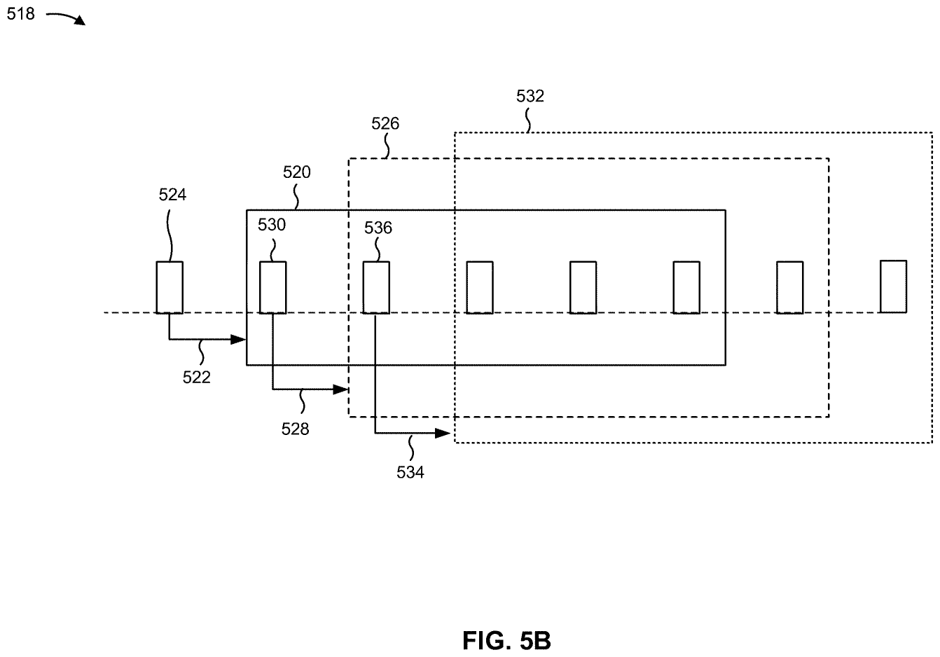

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

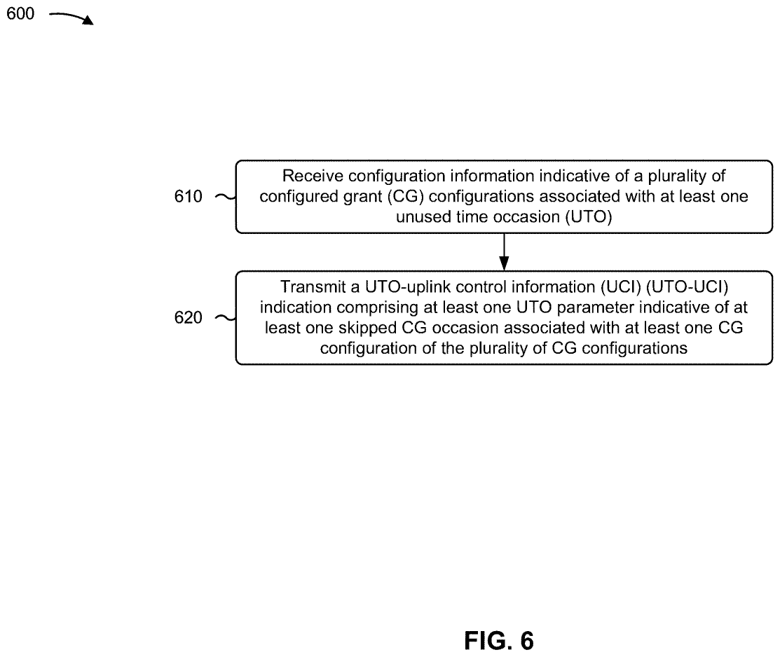

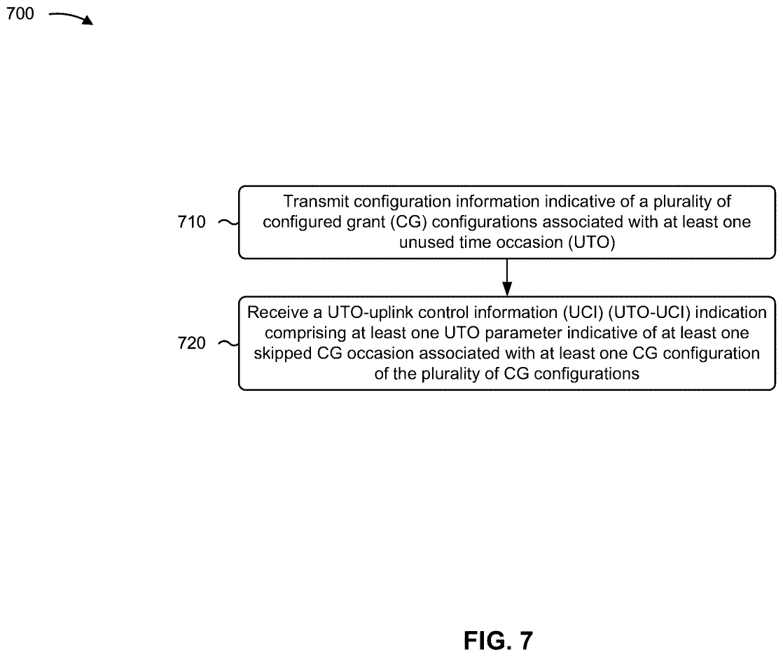

The controller/processor 240 of the network node 110, the controller/processor 280 of the UE 120, and/or any other component(s) of FIG. 2 may perform one or more techniques associated with UTO-UCI indications, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information indicative of a plurality of CG configurations associated with at least one UTO; and/or means for transmitting a UTO-UCI indication comprising at least one UTO parameter indicative of at least one skipped CG occasion associated with at least one CG configuration of the plurality of CG configurations. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting configuration information indicative of a plurality of CG configurations associated with at least one UTO; and/or means for receiving a UTO-UCI indication comprising at least one UTO parameter indicative of at least one skipped CG occasion associated with at least one CG configuration of the plurality of CG configurations. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

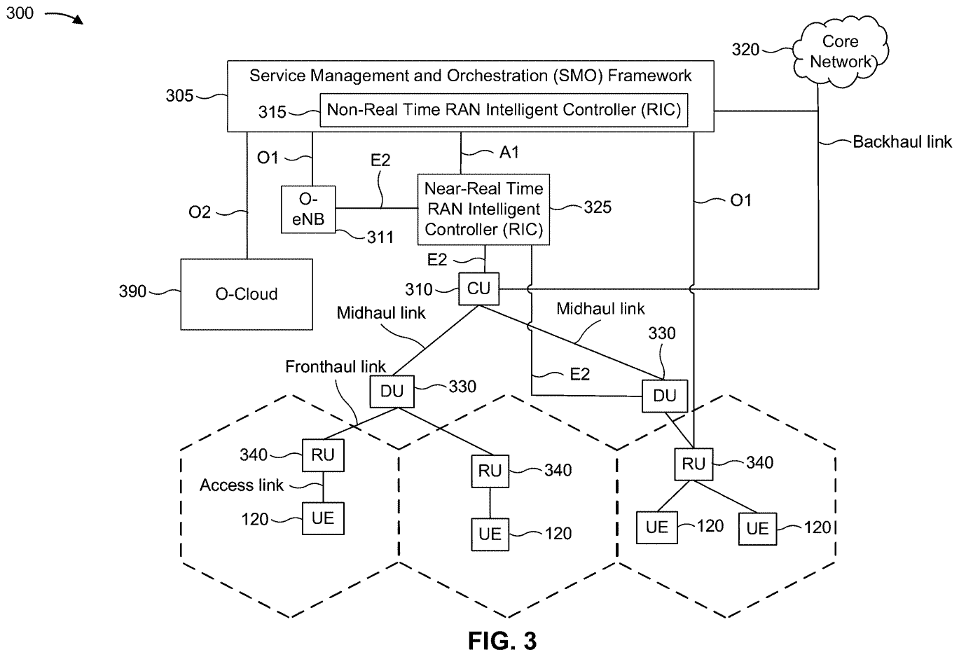

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

As indicated above, FIG. 3 is provided as an example. Other examples may differ from what is described with regard to FIG. 3.

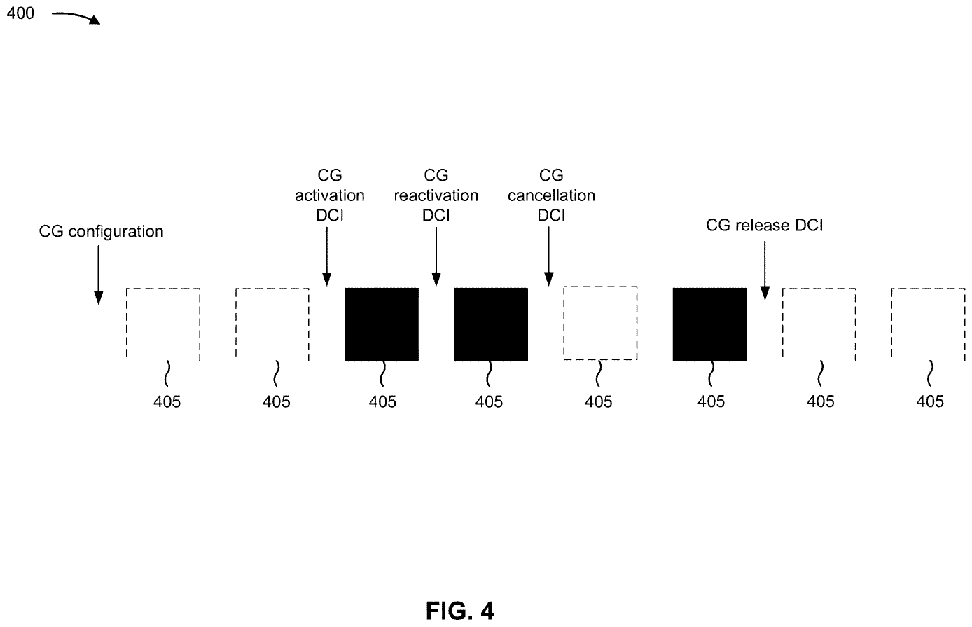

FIG. 4 is a diagram illustrating an example 400 of uplink CG communication, in accordance with the present disclosure. CG communications may include periodic uplink communications that are configured for a UE, such that the network node does not need to send separate downlink control information (DCI) to schedule each uplink communication, thereby conserving signaling overhead.

As shown in example 400, a UE may be configured with a CG configuration for CG communications. For example, the UE may receive the CG configuration via a radio resource control (RRC) message transmitted by a network node. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG instances 405 for the UE. A CG instance 405 can include a CG occasion, a set of CG occasions, or a portion of a CG occasion. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network node may transmit CG activation DCI to the UE to activate the CG configuration for the UE. The network node may indicate, in the CG activation DCI, communication parameters, such as a modulation and coding scheme (MCS), a resource block (RB) allocation, and/or antenna ports, for the CG PUSCH communications to be transmitted in the scheduled CG instances 405. The UE may begin transmitting in the CG instances 405 based at least in part on receiving the CG activation DCI. For example, beginning with a next scheduled CG instance 405 subsequent to receiving the CG activation DCI, the UE may transmit a PUSCH communication in the scheduled CG instances 405 using the communication parameters indicated in the CG activation DCI. The UE may refrain from transmitting in configured CG instances 405 prior to receiving the CG activation DCI.

The network node may transmit CG reactivation DCI to the UE to change the communication parameters for the CG PUSCH communications. Based at least in part on receiving the CG reactivation DCI, the UE may begin transmitting in the scheduled CG instances 405 using the communication parameters indicated in the CG reactivation DCI. For example, beginning with a next scheduled CG instance 405 subsequent to receiving the CG reactivation DCI, the UE may transmit PUSCH communications in the scheduled CG instances 405 based at least in part on the communication parameters indicated in the CG reactivation DCI.

In some cases, such as when the network node needs to override a scheduled CG communication for a higher priority communication, the network node may transmit CG cancellation DCI to the UE to temporarily cancel or deactivate one or more subsequent CG instances 405 for the UE. The CG cancellation DCI may deactivate only a subsequent one CG instance 405 or a subsequent N CG instances 405 (where Nis an integer). CG instances 405 after the one or more (e.g., N) CG instances 405 subsequent to the CG cancellation DCI may remain activated. Based at least in part on receiving the CG cancellation DCI, the UE may refrain from transmitting in the one or more (e.g., N) CG instances 405 subsequent to receiving the CG cancellation DCI. As shown in example 400, the CG cancellation DCI cancels one subsequent CG instance 405 for the UE. After the CG instances 405 (or N CG occasions) subsequent to receiving the CG cancellation DCI, the UE may automatically resume transmission in the scheduled CG instances 405.

The network node may transmit CG release DCI to the UE to deactivate the CG configuration for the UE. The UE may stop transmitting in the scheduled CG instances 405 based at least in part on receiving the CG release DCI. For example, the UE may refrain from transmitting in any scheduled CG instances 405 until another CG activation DCI is received from the network node. Whereas the CG cancellation DCI may deactivate only a subsequent one CG instance 405 or a subsequent N CG instances 405, the CG release DCI deactivates all subsequent CG instances 405 for a given CG configuration for the UE until the given CG configuration is activated again by a new CG activation DCI.

In some cases, a UE may skip one or more CG occasions and may indicate the skipped CG PUSCH occasion(s) based on uplink control information (UCI) (e.g., CG-UCI or a new UCI). In some aspects, multiple CG PUSCH transmission occasions may be scheduled in a period of a single CG PUSCH configuration. In some aspects, the UCI may be transmitted in a UTO and may be referred to as UTO-UCI. Indication of UTO-UCI by CG PUSCHs associated to a CG configuration may be enabled by configuration of an RRC parameter. In some aspects, to facilitate multiple CG configuration scheduling, a UTO period parameter may be configured to indicate a length of a UTO period. In some aspects, the UTO period may be any value of time. In some aspects, the UTO period may have a value associated with one or more CG periodicities (e.g., specified by an integer value). In some cases, a UTO offset parameter may indicate a UTO offset. In some cases, the UTO offset may be configured and/or specified by a wireless communication standard. In some cases, a transmitted CG PUSCH can carry UTO-UCI that is applicable to the valid CG PUSCH time occasions that are confined within the UTO period starting with a UTO offset from the end of the transmitted CG PUSCH. However, without indication of the UTO parameters, a network node may not be able to receive communications during UTOs.

Some aspects of the techniques described herein provide for transmitting UTO-UCI indications. The UTO-UCI indications may include at least one UTO parameter indicative of at least one skipped CG occasion associated with at least one CG configuration of a plurality of CG configurations. In this way, some aspects may facilitate reception, at the network, of UTO-UCI, thereby positively impacting network performance.

As indicated above, FIG. 4 is provided as an example. Other examples may differ from what is described with respect to FIG. 4.

FIG. 5A is a diagram illustrating an example 500 associated with UTO-UCI indications, in accordance with the present disclosure. As shown, for example, a UE 502 and a network node 504 may communicate with one another. The UE 502 may be, be similar to, include, or be included in, the UE 120 depicted in FIGS. 1-3. The network node 504 may be, be similar to, include, or be included in, the network node 110 depicted in FIGS. 1 and 2 and/or one or more components of the disaggregated base station architecture 300 depicted in FIG. 3.

As shown by reference number 506, the network node 504 may transmit, and the UE 502 may receive, configuration information. The configuration information may be indicative of a plurality of CG configurations associated with at least one UTO. As shown by reference number 508, the UE 502 may transmit, and the network node 504 may receive, a UTO-UCI indication. The UTO-UCI indication may include at least one UTO parameter indicative of at least one skipped CG occasion associated with at least one CG configuration of the plurality of CG configurations. In some aspects, the at least one UTO parameter may include one or more UTO period parameters and/or one or more UTO offset parameters. In some aspects, the configuration information may indicate the at least one UTO parameter. In some aspects, the at least one UTO parameter may include one or more RRC parameters.

In some aspects, the at least one UTO parameter may include a UTO period parameter and a UTO offset parameter, and the UTO period parameter may be configured common to the plurality of CG configurations and the UTO offset parameter may be configured common to the plurality of CG configurations. In some aspects, the common configurations may be applicable when UTO-UCI is applied for either single or multiple CG configurations.

In some aspects, the at least one UTO parameter may include a plurality of UTO period parameters and a plurality of UTO offset parameters. Each UTO period parameter of the plurality of UTO period parameters may be associated with a respective CG configuration of the plurality of CG configurations. For example, as shown in FIG. 5A, a first UTO period parameter (e.g., UTO period time value) 510 may be associated with a first CG configuration 512 and a second UTO period parameter 514 may be associated with a second CG configuration 516. In this way, the UTO period parameter may be configured per CG configuration. Similarly, the UTO offset parameter may be configured per CG configuration. Thus, in some aspects, each UTO offset parameter of the plurality of UTO offset parameters may be associated with a respective CG configuration of the plurality of CG configurations. The per-applicable CG configuration parameter configuration may be applicable, for example, when the UTO-UCI is applied for a single CG configuration.

In some aspects, the UTO period parameter may be configured common to applicable CG configurations and the UTO offset parameter may be per-CG configuration configured (e.g., when the UTO-UCI is applied for single and/or multiple CG configurations). In some aspects, the UTO period parameter may be configured per applicable CG configuration and the UTO offset parameter may be configured common to applicable CG configurations (e.g., when the UTO-UCI is applied for a single configuration).

In some aspects, if the UE 502 is explicitly not configured with a UTO period parameter for UTO-UCI indications to indicate skipped CG occasions associated with one or more CG configurations, the UTO period parameter may be implicitly determined. For example, the UTO period parameter may be implicitly determined by the CG period if the UTO-UCI is applicable to a single CG configuration or by a selected CG period if the UTO-UCI is applicable to multiple CG configurations. The selected CG configuration may be associated with a CG period satisfying a period condition. In some aspects, the selected CG period may be a longest CG period, a shortest CG period, a CG period of a CG configuration having a lowest CG configuration identifier (ID), or a CG period of a CG configuration having a highest CG configuration ID. For example, the CG period may satisfy the period condition based on being a longest CG period of a plurality of CG periods associated with the plurality of CG configurations. As another example, the CG period may satisfy the period condition based on being a shortest CG period of a plurality of CG periods associated with the plurality of CG configurations. As another example, the selected CG configuration may be associated with a CG period satisfying a CG identifier condition. For example, the CG period may satisfy the CG identifier condition based on being a highest CG identifier value of a plurality of CG identifier values associated with the plurality of CG configurations or the CG period may satisfy the CG identifier condition based on being a lowest CG identifier value of a plurality of CG identifier values associated with the plurality of CG configurations.

In some aspects, if the UE 502 is explicitly not configured with a UTO offset parameter for UTO-UCI indications to indicate skipped CG occasions associated with one or more CG configurations, the UTO offset parameter may be determined by a predetermined value (e.g., 0 or 1). The predetermined value may be configured and/or indicated by a wireless communication standard.

In some aspects, the UE 502 may determine a starting time of a UTO periodicity (e.g., a starting time of a first UTO period). In some aspects, for example, the UTO periodicity may be a fixed window periodicity and, in other aspects, the UTO periodicity may be a floating window periodicity. In the case of a fixed-window periodicity, the configuration information may indicate a starting time of a first UTO period of the plurality of UTO periods, and at least one additional starting time of at least one additional UTO period of the plurality of UTO periods may be based on the first UTO period. In some aspects, a starting time of a first UTO period of the plurality of UTO periods may correspond to a starting time of a first CG period of a first CG configuration of the plurality of CG configurations, and at least one additional starting time of at least one additional UTO period of the plurality of UTO periods may be based on the first UTO period. In some aspects, where the UTO-UCI indication is associated with a single CG configuration, the first CG configuration may be the single CG configuration. In some aspects, where the UTO-UCI indication is associated with the plurality of CG configurations, the first CG configuration may be a selected CG configuration of the plurality of CG configurations. For example, the selected CG configuration may be associated with a CG period satisfying a period condition. In some aspects, the CG period may satisfy the period condition based on being a longest CG period of a plurality of CG periods associated with the plurality of CG configurations or a shortest CG period of a plurality of CG periods associated with the plurality of CG configurations. In some aspects, the selected CG configuration may be associated with a CG period satisfying a CG ID condition. For example, the CG period may satisfy the CG ID condition based on being a highest CG identifier value of a plurality of CG ID values associated with the plurality of CG configurations or a lowest CG ID value of a plurality of CG ID values associated with the plurality of CG configurations. In some aspects, the configuration information may indicate the selected CG configuration.

FIG. 5B is a diagram illustrating an example 518 associated with floating window periodicities for UTO-UCI indications, according to the present disclosure. For example, as shown, a first UTO period 520 may correspond to a first offset 522 from an ending time of a first transmitted CG PUSCH 524, a second UTO period 526 may correspond to a second offset 528 from an ending time of a second transmitted CG PUSCH 530, and a third UTO period 532 may correspond to a third offset 534 from an ending time of a third transmitted CG PUSCH 536.

In some aspects, the UE 502 may refrain from transmitting the UTO-UCI in a CG PUSCH occasion within a UTO offset starting from an end of a CG PUSCH occasion in a UTO period. In some aspects, the UE 502 may transmit the UTO-UCI in a first CG PUSCH occasion occurring prior to a UTO offset that starts from an end of a second CG PUSCH occasion in a UTO period. In some aspects, a length of the UTO-UCI may be based on a transmitted time occasion associated with the first CG PUSCH occasion.

As indicated above, FIGS. 5A and 5B are provided as examples. Other examples may differ from what is described with respect to FIGS. 5A and 5B.

FIG. 6 is a diagram illustrating an example process 600 performed, for example, by a UE, in accordance with the present disclosure. Example process 600 is an example where the UE (e.g., UE 502) performs operations associated with UTO-UCI indications.

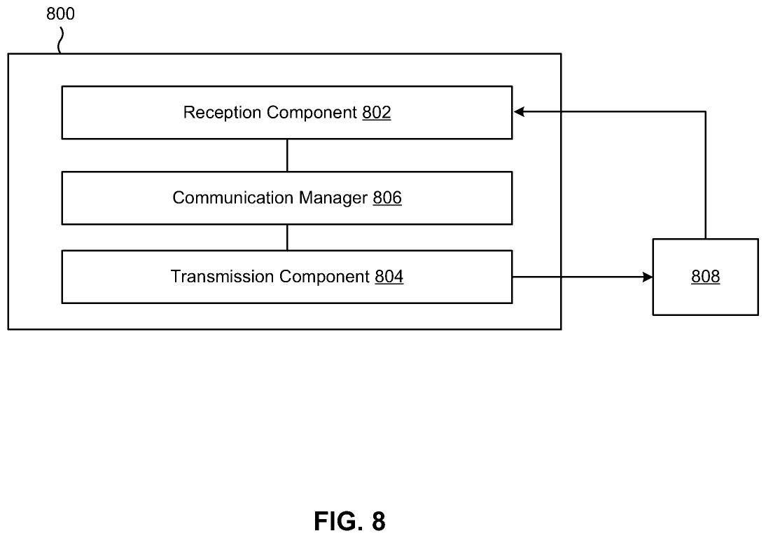

As shown in FIG. 6, in some aspects, process 600 may include receiving configuration information indicative of a plurality of CG configurations associated with at least one UTO (block 610). For example, the UE (e.g., using reception component 802 and/or communication manager 806, depicted in FIG. 8) may receive configuration information indicative of a plurality of CG configurations associated with at least one UTO, as described above.

As further shown in FIG. 6, in some aspects, process 600 may include transmitting a UTO-UCI indication comprising at least one UTO parameter indicative of at least one skipped CG occasion associated with at least one CG configuration of the plurality of CG configurations (block 620). For example, the UE (e.g., using transmission component 804 and/or communication manager 806, depicted in FIG. 8) may transmit a UTO-UCI indication comprising at least one UTO parameter indicative of at least one skipped CG occasion associated with at least one CG configuration of the plurality of CG configurations, as described above.

Process 600 may include additional aspects, such as any single aspect or any combination of aspects described below and/or in connection with one or more other processes described elsewhere herein.

In a first aspect, the at least one UTO parameter comprises at least one of a UTO period parameter or a UTO offset parameter. In a second aspect, alone or in combination with the first aspect, the configuration information indicates the at least one of the UTO period parameter or the UTO offset parameter. In a third aspect, alone or in combination with one or more of the first and second aspects, the at least one UTO parameter comprises a UTO period parameter and a UTO offset parameter, and the UTO period parameter is configured common to the plurality of CG configurations and the UTO offset parameter is configured common to the plurality of CG configurations. In a fourth aspect, alone or in combination with one or more of the first and second aspects, the at least one UTO parameter comprises a plurality of UTO period parameters and a plurality of UTO offset parameters, wherein each UTO period parameter of the plurality of UTO period parameters is associated with a respective CG configuration of the plurality of CG configurations, and each UTO offset parameter of the plurality of UTO offset parameters is associated with a respective CG configuration of the plurality of CG configurations. In a fifth aspect, alone or in combination with one or more of the first and second aspects, the at least one UTO parameter comprises a UTO period parameter and a plurality of UTO offset parameters, wherein the UTO period parameter is configured common to the plurality of CG configurations, and each UTO offset parameter of the plurality of UTO offset parameters is associated with a respective CG configuration of the plurality of CG configurations. In a sixth aspect, alone or in combination with one or more of the first and second aspects, the at least one UTO parameter comprises a plurality of UTO period parameters and a UTO offset parameter, wherein each UTO period parameter of the plurality of UTO period parameters is associated with a respective CG configuration of the plurality of CG configurations, and the UTO offset parameter is configured common to the plurality of CG configurations.

In a seventh aspect, alone or in combination with one or more of the first and second aspects, the at least one UTO parameter comprises a UTO period parameter, and the UTO period parameter is based on a CG period associated with a CG configuration of the plurality of CG configurations. In an eighth aspect, alone or in combination with the seventh aspect, the at least one UTO parameter comprises at least one additional UTO period parameter, and each additional UTO period parameter of the at least one additional UTO period parameter is based on a respective additional CG period associated with a respective additional CG configuration of the plurality of CG configurations. In a ninth aspect, alone or in combination with one or more of the first and second aspects, the at least one UTO parameter comprises a UTO period parameter associated with the plurality of CG configurations, wherein the configuration information omits a configuration of the UTO period parameter, and, based on the configuration information omitting the configuration of the UTO period parameter, the UTO period parameter is based on a selected CG configuration of the plurality of CG configurations.

In a tenth aspect, alone or in combination with the ninth aspect, the selected CG configuration is associated with a CG period satisfying a period condition. In an eleventh aspect, alone or in combination with the tenth aspect, the CG period satisfies the period condition based on being a longest CG period of a plurality of CG periods associated with the plurality of CG configurations. In a twelfth aspect, alone or in combination with the eleventh aspect, the CG period satisfies the period condition based on being a shortest CG period of a plurality of CG periods associated with the plurality of CG configurations. In a thirteenth aspect, alone or in combination with one or more of the ninth through twelfth aspects, the selected CG configuration is associated with a CG period satisfying a CG identifier condition. In a fourteenth aspect, alone or in combination with the thirteenth aspect, the CG period satisfies the CG identifier condition based on being a highest CG identifier value of a plurality of CG identifier values associated with the plurality of CG configurations. In a fifteenth aspect, alone or in combination with the thirteenth aspect, the CG period satisfies the CG identifier condition based on being a lowest CG identifier value of a plurality of CG identifier values associated with the plurality of CG configurations.

In a sixteenth aspect, alone or in combination with one or more of the first and second aspects, the at least one UTO parameter comprises a UTO offset parameter associated with the plurality of CG configurations, wherein the configuration information omits a configuration of the UTO offset parameter, and, based on the configuration information omitting the configuration of the UTO offset parameter, the UTO offset parameter is based on a specified value. In a seventeenth aspect, the UTO-UCI indication is associated with a UTO periodicity comprising a plurality of UTO periods.

In an eighteenth aspect, alone or in combination with the seventeenth aspect, the UTO periodicity comprises a fixed-window periodicity. In a nineteenth aspect, alone or in combination with one or more of the seventeenth through eighteenth aspects, the configuration information indicates a starting time of a first UTO period of the plurality of UTO periods, and at least one additional starting time of at least one additional UTO period of the plurality of UTO periods is based on the first UTO period. In a twentieth aspect, alone or in combination with the seventeenth aspect, a starting time of a first UTO period of the plurality of UTO periods corresponds to a starting time of a first CG period of a first CG configuration of the plurality of CG configurations, and at least one additional starting time of at least one additional UTO period of the plurality of UTO periods is based on the first UTO period. In a twenty-first aspect, alone or in combination with the twentieth aspect, the UTO-UCI indication is associated with a single CG configuration, and the first CG configuration comprises the single CG configuration.

In a twenty-second aspect, alone or in combination with the twentieth aspect, the UTO-UCI indication is associated with the plurality of CG configurations, and the first CG configuration comprises a selected CG configuration of the plurality of CG configurations. In a twenty-third aspect, alone or in combination with the twenty-second aspect, the selected CG configuration is associated with a CG period satisfying a period condition. In a twenty-fourth aspect, alone or in combination with the twenty-third aspect, the CG period satisfies the period condition based on being a longest CG period of a plurality of CG periods associated with the plurality of CG configurations.

In a twenty-fifth aspect, alone or in combination with the twenty-third aspect, the CG period satisfies the period condition based on being a shortest CG period of a plurality of CG periods associated with the plurality of CG configurations. In a twenty-sixth aspect, alone or in combination with one or more of the twenty-second through twenty-fifth aspects, the selected CG configuration is associated with a CG period satisfying a CG identifier condition. In a twenty-seventh aspect, alone or in combination with the twenty-sixth aspect, the CG period satisfies the CG identifier condition based on being a highest CG identifier value of a plurality of CG identifier values associated with the plurality of CG configurations. In a twenty-eighth aspect, alone or in combination with the twenty-sixth aspect, the CG period satisfies the CG identifier condition based on being a lowest CG identifier value of a plurality of CG identifier values associated with the plurality of CG configurations. In a twenty-ninth aspect, alone or in combination with one or more of the twenty-second through twenty-eighth aspects, the configuration information indicates the selected CG configuration.

In a thirtieth aspect, alone or in combination with one or more of the first through twenty-ninth aspects, the UTO periodicity comprises a floating window periodicity. In a thirty-first aspect, alone or in combination with one or more of the first through thirtieth aspects, a starting time of a first UTO period of the plurality of UTO periods corresponds to a UTO offset from an ending time of a transmitted CG physical uplink shared channel. In a thirty-second aspect, alone or in combination with one or more of the first through thirty-first aspects, transmitting the UTO-UCI comprises refraining from transmitting the UTO-UCI in a CG PUSCH occasion within a UTO offset starting from an end of a CG PUSCH occasion in a UTO period. In a thirty-third aspect, alone or in combination with one or more of the first through thirty-second aspects, transmitting the UTO-UCI comprises transmitting the UTO-UCI in a first CG PUSCH occasion occurring prior to a UTO offset that starts from an end of a second CG PUSCH occasion in a UTO period, and a length of the UTO-UCI is based on a transmitted time occasion associated with the first CG PUSCH occasion.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with UTO-UCI indications.

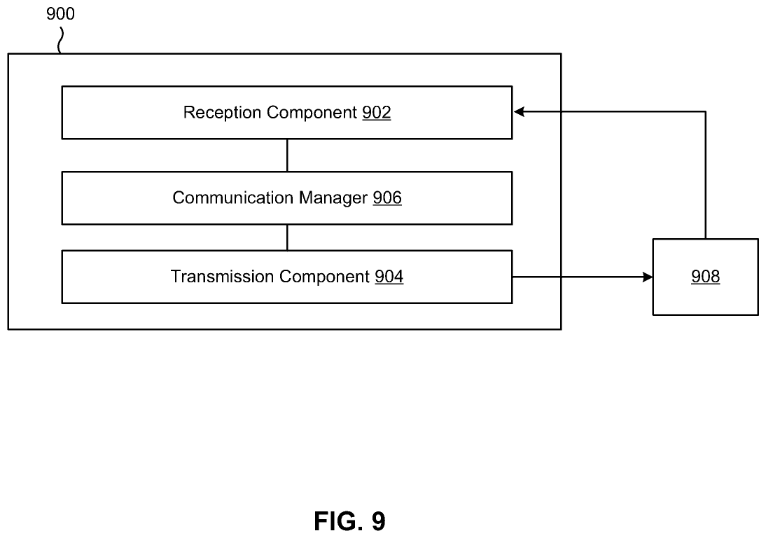

As shown in FIG. 7, in some aspects, process 700 may include transmitting configuration information indicative of a plurality of CG configurations associated with at least one UTO (block 710). For example, the network node (e.g., using transmission component 904 and/or communication manager 906, depicted in FIG. 9) may transmit configuration information indicative of a plurality of CG configurations associated with at least one UTO, as described above.

As further shown in FIG. 7, in some aspects, process 700 may include receiving a UTO-UCI indication comprising at least one UTO parameter indicative of at least one skipped CG occasion associated with at least one CG configuration of the plurality of CG configurations (block 720). For example, the network node (e.g., using reception component 902 and/or communication manager 906, depicted in FIG. 9) may receive a UTO-UCI indication comprising at least one UTO parameter indicative of at least one skipped CG occasion associated with at least one CG configuration of the plurality of CG configurations, as described above.

Process 700 may include additional aspects, such as any single aspect or any combination of aspects described below and/or in connection with one or more other processes described elsewhere herein.

In a first aspect, the at least one UTO parameter comprises at least one of a UTO period parameter or a UTO offset parameter. In a second aspect, alone or in combination with the first aspect, the configuration information indicates the at least one of the UTO period parameter or the UTO offset parameter. In a third aspect, alone or in combination with one or more of the first and second aspects, the at least one UTO parameter comprises a UTO period parameter and a UTO offset parameter, and the UTO period parameter is configured common to the plurality of CG configurations and the UTO offset parameter is configured common to the plurality of CG configurations. In a fourth aspect, alone or in combination with one or more of the first and second aspects, the at least one UTO parameter comprises a plurality of UTO period parameters and a plurality of UTO offset parameters, wherein each UTO period parameter of the plurality of UTO period parameters is associated with a respective CG configuration of the plurality of CG configurations, and each UTO offset parameter of the plurality of UTO offset parameters is associated with a respective CG configuration of the plurality of CG configurations. In a fifth aspect, alone or in combination with one or more of the first and second aspects, the at least one UTO parameter comprises a UTO period parameter and a plurality of UTO offset parameters, wherein the UTO period parameter is configured common to the plurality of CG configurations, and each UTO offset parameter of the plurality of UTO offset parameters is associated with a respective CG configuration of the plurality of CG configurations. In a sixth aspect, alone or in combination with one or more of the first and second aspects, the at least one UTO parameter comprises a plurality of UTO period parameters and a UTO offset parameter, wherein each UTO period parameter of the plurality of UTO period parameters is associated with a respective CG configuration of the plurality of CG configurations, and the UTO offset parameter is configured common to the plurality of CG configurations.

In a seventh aspect, alone or in combination with one or more of the first and second aspects, the at least one UTO parameter comprises a UTO period parameter, and the UTO period parameter is based on a CG period associated with a CG configuration of the plurality of CG configurations. In an eighth aspect, alone or in combination with one or more of the first and second aspects, the at least one UTO parameter comprises at least one additional UTO period parameter, and each additional UTO period parameter of the at least one additional UTO period parameter is based on a respective additional CG period associated with a respective additional CG configuration of the plurality of CG configurations. In a ninth aspect, alone or in combination with one or more of the first and second aspects, the at least one UTO parameter comprises a UTO period parameter associated with the plurality of CG configurations, wherein the configuration information omits a configuration of the UTO period parameter, and, based on the configuration information omitting the configuration of the UTO period parameter, the UTO period parameter is based on a selected CG configuration of the plurality of CG configurations.

In a tenth aspect, alone or in combination with the ninth aspect, the selected CG configuration is associated with a CG period satisfying a period condition. In an eleventh aspect, alone or in combination with the tenth aspect, the CG period satisfies the period condition based on being a longest CG period of a plurality of CG periods associated with the plurality of CG configurations. In a twelfth aspect, alone or in combination with the tenth aspect, the CG period satisfies the period condition based on being a shortest CG period of a plurality of CG periods associated with the plurality of CG configurations. In a thirteenth aspect, alone or in combination with one or more of the ninth through twelfth aspects, the selected CG configuration is associated with a CG period satisfying a CG identifier condition. In a fourteenth aspect, alone or in combination with the thirteenth aspect, the CG period satisfies the CG identifier condition based on being a highest CG identifier value of a plurality of CG identifier values associated with the plurality of CG configurations. In a fifteenth aspect, alone or in combination with the thirteenth aspect, the CG period satisfies the CG identifier condition based on being a lowest CG identifier value of a plurality of CG identifier values associated with the plurality of CG configurations.

In a sixteenth aspect, alone or in combination with one or more of the first through fifteenth aspects, the at least one UTO parameter comprises a UTO offset parameter associated with the plurality of CG configurations, wherein the configuration information omits a configuration of the UTO offset parameter, and, based on the configuration information omitting the configuration of the UTO offset parameter, the UTO offset parameter is based on a specified value. In a seventeenth aspect, alone or in combination with one or more of the first through sixteenth aspects, the UTO-UCI indication is associated with a UTO periodicity comprising a plurality of UTO periods.

In an eighteenth aspect, alone or in combination with the seventeenth aspect, the UTO periodicity comprises a fixed-window periodicity. In a nineteenth aspect, alone or in combination with one or more of the seventeenth through eighteenth aspects, the configuration information indicates a starting time of a first UTO period of the plurality of UTO periods, and at least one additional starting time of at least one additional UTO period of the plurality of UTO periods is based on the first UTO period. In a twentieth aspect, alone or in combination with the seventeenth aspect, a starting time of a first UTO period of the plurality of UTO periods corresponds to a starting time of a first CG period of a first CG configuration of the plurality of CG configurations, and at least one additional starting time of at least one additional UTO period of the plurality of UTO periods is based on the first UTO period. In a twenty-first aspect, alone or in combination with the twentieth aspect, the UTO-UCI indication is associated with a single CG configuration, and the first CG configuration comprises the single CG configuration. In a twenty-second aspect, alone or in combination with the twentieth aspect, the UTO-UCI indication is associated with the plurality of CG configurations, and the first CG configuration comprises a selected CG configuration of the plurality of CG configurations.

In a twenty-third aspect, alone or in combination with the twenty-second aspect, the selected CG configuration is associated with a CG period satisfying a period condition. In a twenty-fourth aspect, alone or in combination with the twenty-third aspect, the CG period satisfies the period condition based on being a longest CG period of a plurality of CG periods associated with the plurality of CG configurations. In a twenty-fifth aspect, alone or in combination with the twenty-third aspect, the CG period satisfies the period condition based on being a shortest CG period of a plurality of CG periods associated with the plurality of CG configurations. In a twenty-sixth aspect, alone or in combination with the twenty-second aspect, the selected CG configuration is associated with a CG period satisfying a CG identifier condition. In a twenty-seventh aspect, alone or in combination with the twenty-sixth aspect, the CG period satisfies the CG identifier condition based on being a highest CG identifier value of a plurality of CG identifier values associated with the plurality of CG configurations. In a twenty-eighth aspect, alone or in combination with the twenty-sixth aspect, the CG period satisfies the CG identifier condition based on being a lowest CG identifier value of a plurality of CG identifier values associated with the plurality of CG configurations. In a twenty-ninth aspect, alone or in combination with the twenty-second aspect, the configuration information indicates the selected CG configuration.

In a thirtieth aspect, alone or in combination with the seventeenth aspect, the UTO periodicity comprises a floating window periodicity. In a thirty-first aspect, alone or in combination with the seventeenth aspect, a starting time of a first UTO period of the plurality of UTO periods corresponds to a UTO offset from an ending time of a transmitted CG physical uplink shared channel. In a thirty-second aspect, alone or in combination with the seventeenth aspect, receiving the UTO-UCI comprises receiving the UTO-UCI in a first CG PUSCH occasion occurring prior to a UTO offset that starts from an end of a second CG PUSCH occasion in a UTO period, and a length of the UTO-UCI is based on a transmitted time occasion associated with the first CG PUSCH occasion.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive configuration information indicative of a plurality of CG configurations associated with at least one UTO. The transmission component 804 may transmit a UTO-UCI indication comprising at least one UTO parameter indicative of at least one skipped CG occasion associated with at least one CG configuration of the plurality of CG configurations.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit configuration information indicative of a plurality of CG configurations associated with at least one UTO. The reception component 902 may receive a UTO-UCI indication comprising at least one UTO parameter indicative of at least one skipped CG occasion associated with at least one CG configuration of the plurality of CG configurations.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving configuration information indicative of a plurality of configured grant (CG) configurations associated with at least one unused time occasion (UTO); and transmitting a UTO-uplink control information (UCI) (UTO-UCI) indication comprising at least one UTO parameter indicative of at least one skipped CG occasion associated with at least one CG configuration of the plurality of CG configurations.

Aspect 2: The method of Aspect 1, wherein the at least one UTO parameter comprises at least one of a UTO period parameter or a UTO offset parameter.

Aspect 3: The method of Aspect 2, wherein the configuration information indicates the at least one of the UTO period parameter or the UTO offset parameter.

Aspect 4: The method of any of Aspects 1-3, wherein the at least one UTO parameter comprises a UTO period parameter and a UTO offset parameter, and wherein the UTO period parameter is configured common to the plurality of CG configurations and the UTO offset parameter is configured common to the plurality of CG configurations.

Aspect 5: The method of any of Aspects 1-3, wherein the at least one UTO parameter comprises a plurality of UTO period parameters and a plurality of UTO offset parameters, wherein each UTO period parameter of the plurality of UTO period parameters is associated with a respective CG configuration of the plurality of CG configurations, and wherein each UTO offset parameter of the plurality of UTO offset parameters is associated with a respective CG configuration of the plurality of CG configurations.

Aspect 6: The method of any of Aspects 1-3, wherein the at least one UTO parameter comprises a UTO period parameter and a plurality of UTO offset parameters, wherein the UTO period parameter is configured common to the plurality of CG configurations, and wherein each UTO offset parameter of the plurality of UTO offset parameters is associated with a respective CG configuration of the plurality of CG configurations.

Aspect 7: The method of any of Aspects 1-3, wherein the at least one UTO parameter comprises a plurality of UTO period parameters and a UTO offset parameter, wherein each UTO period parameter of the plurality of UTO period parameters is associated with a respective CG configuration of the plurality of CG configurations, and wherein the UTO offset parameter is configured common to the plurality of CG configurations.

Aspect 8: The method of any of Aspects 1-3, wherein the at least one UTO parameter comprises a UTO period parameter, and wherein the UTO period parameter is based on a CG period associated with a CG configuration of the plurality of CG configurations.

Aspect 9: The method of Aspect 8, wherein the at least one UTO parameter comprises at least one additional UTO period parameter, and wherein each additional UTO period parameter of the at least one additional UTO period parameter is based on a respective additional CG period associated with a respective additional CG configuration of the plurality of CG configurations.

Aspect 10: The method of any of Aspects 1-3, wherein the at least one UTO parameter comprises a UTO period parameter associated with the plurality of CG configurations, wherein the configuration information omits a configuration of the UTO period parameter, and wherein, based on the configuration information omitting the configuration of the UTO period parameter, the UTO period parameter is based on a selected CG configuration of the plurality of CG configurations.

Aspect 11: The method of Aspect 10, wherein the selected CG configuration is associated with a CG period satisfying a period condition.

Aspect 12: The method of Aspect 11, wherein the CG period satisfies the period condition based on being a longest CG period of a plurality of CG periods associated with the plurality of CG configurations.

Aspect 13: The method of Aspect 11, wherein the CG period satisfies the period condition based on being a shortest CG period of a plurality of CG periods associated with the plurality of CG configurations.

Aspect 14: The method of any of Aspects 10-13, wherein the selected CG configuration is associated with a CG period satisfying a CG identifier condition.

Aspect 15: The method of Aspect 14, wherein the CG period satisfies the CG identifier condition based on being a highest CG identifier value of a plurality of CG identifier values associated with the plurality of CG configurations.

Aspect 16: The method of any of Aspects 14-15, wherein the CG period satisfies the CG identifier condition based on being a lowest CG identifier value of a plurality of CG identifier values associated with the plurality of CG configurations.

Aspect 17: The method of any of Aspects 1-3, wherein the at least one UTO parameter comprises a UTO offset parameter associated with the plurality of CG configurations, wherein the configuration information omits a configuration of the UTO offset parameter, and wherein, based on the configuration information omitting the configuration of the UTO offset parameter, the UTO offset parameter is based on a specified value.

Aspect 18: The method of Aspect 1, wherein the UTO-UCI indication is associated with a UTO periodicity comprising a plurality of UTO periods.

Aspect 19: The method of Aspect 18, wherein the UTO periodicity comprises a fixed-window periodicity.

Aspect 20: The method of either of Aspects 18 or 19, wherein the configuration information indicates a starting time of a first UTO period of the plurality of UTO periods, and wherein at least one additional starting time of at least one additional UTO period of the plurality of UTO periods is based on the first UTO period.

Aspect 21: The method of Aspect 18, wherein a starting time of a first UTO period of the plurality of UTO periods corresponds to a starting time of a first CG period of a first CG configuration of the plurality of CG configurations, and wherein at least one additional starting time of at least one additional UTO period of the plurality of UTO periods is based on the first UTO period.

Aspect 22: The method of Aspect 21, wherein the UTO-UCI indication is associated with a single CG configuration, and wherein the first CG configuration comprises the single CG configuration.

Aspect 23: The method of Aspect 21, wherein the UTO-UCI indication is associated with the plurality of CG configurations, and wherein the first CG configuration comprises a selected CG configuration of the plurality of CG configurations.

Aspect 24: The method of Aspect 23, wherein the selected CG configuration is associated with a CG period satisfying a period condition.

Aspect 25: The method of Aspect 24, wherein the CG period satisfies the period condition based on being a longest CG period of a plurality of CG periods associated with the plurality of CG configurations.

Aspect 26: The method of Aspect 24, wherein the CG period satisfies the period condition based on being a shortest CG period of a plurality of CG periods associated with the plurality of CG configurations.

Aspect 27: The method of any of Aspects 23-26, wherein the selected CG configuration is associated with a CG period satisfying a CG identifier condition.

Aspect 28: The method of Aspect 27, wherein the CG period satisfies the CG identifier condition based on being a highest CG identifier value of a plurality of CG identifier values associated with the plurality of CG configurations.

Aspect 29: The method of any of Aspects 27-28, wherein the CG period satisfies the CG identifier condition based on being a lowest CG identifier value of a plurality of CG identifier values associated with the plurality of CG configurations.

Aspect 30: The method of any of Aspects 23-29, wherein the configuration information indicates the selected CG configuration.

Aspect 31: The method of any of Aspects 18-30, wherein the UTO periodicity comprises a floating window periodicity.

Aspect 32: The method of any of Aspects 18-31, wherein a starting time of a first UTO period of the plurality of UTO periods corresponds to a UTO offset from an ending time of a transmitted CG physical uplink shared channel.

Aspect 33: The method of any of Aspects 18-32, wherein transmitting the UTO-UCI comprises refraining from transmitting the UTO-UCI in a CG physical uplink shared channel (PUSCH) occasion within a UTO offset starting from an end of a CG PUSCH occasion in a UTO period.

Aspect 34: The method of any of Aspects 18-33, wherein transmitting the UTO-UCI comprises transmitting the UTO-UCI in a first CG physical uplink shared channel (PUSCH) occasion occurring prior to a UTO offset that starts from an end of a second CG PUSCH occasion in a UTO period, and wherein a length of the UTO-UCI is based on a transmitted time occasion associated with the first CG PUSCH occasion.

Aspect 35: A method of wireless communication performed by a network node, comprising: transmitting configuration information indicative of a plurality of configured grant (CG) configurations associated with at least one unused time occasion (UTO); and receiving a UTO-uplink control information (UCI) (UTO-UCI) indication comprising at least one UTO parameter indicative of at least one skipped CG occasion associated with at least one CG configuration of the plurality of CG configurations.

Aspect 36: The method of Aspect 35, wherein the at least one UTO parameter comprises at least one of a UTO period parameter or a UTO offset parameter.

Aspect 37: The method of Aspect 36, wherein the configuration information indicates the at least one of the UTO period parameter or the UTO offset parameter.

Aspect 38: The method of any of Aspects 35-37, wherein the at least one UTO parameter comprises a UTO period parameter and a UTO offset parameter, and wherein the UTO period parameter is configured common to the plurality of CG configurations and the UTO offset parameter is configured common to the plurality of CG configurations.

Aspect 39: The method of any of Aspects 35-37, wherein the at least one UTO parameter comprises a plurality of UTO period parameters and a plurality of UTO offset parameters, wherein each UTO period parameter of the plurality of UTO period parameters is associated with a respective CG configuration of the plurality of CG configurations, and wherein each UTO offset parameter of the plurality of UTO offset parameters is associated with a respective CG configuration of the plurality of CG configurations.

Aspect 40: The method of any of Aspects 35-37, wherein the at least one UTO parameter comprises a UTO period parameter and a plurality of UTO offset parameters, wherein the UTO period parameter is configured common to the plurality of CG configurations, and wherein each UTO offset parameter of the plurality of UTO offset parameters is associated with a respective CG configuration of the plurality of CG configurations.

Aspect 41: The method of any of Aspects 35-37, wherein the at least one UTO parameter comprises a plurality of UTO period parameters and a UTO offset parameter, wherein each UTO period parameter of the plurality of UTO period parameters is associated with a respective CG configuration of the plurality of CG configurations, and wherein the UTO offset parameter is configured common to the plurality of CG configurations.

Aspect 42: The method of any of Aspects 35-37, wherein the at least one UTO parameter comprises a UTO period parameter, and wherein the UTO period parameter is based on a CG period associated with a CG configuration of the plurality of CG configurations.

Aspect 43: The method of any of Aspects 35-37, wherein the at least one UTO parameter comprises at least one additional UTO period parameter, and wherein each additional UTO period parameter of the at least one additional UTO period parameter is based on a respective additional CG period associated with a respective additional CG configuration of the plurality of CG configurations.

Aspect 44: The method of any of Aspects 35-37, wherein the at least one UTO parameter comprises a UTO period parameter associated with the plurality of CG configurations, wherein the configuration information omits a configuration of the UTO period parameter, and wherein, based on the configuration information omitting the configuration of the UTO period parameter, the UTO period parameter is based on a selected CG configuration of the plurality of CG configurations.

Aspect 45: The method of Aspect 44, wherein the selected CG configuration is associated with a CG period satisfying a period condition.

Aspect 46: The method of Aspect 45, wherein the CG period satisfies the period condition based on being a longest CG period of a plurality of CG periods associated with the plurality of CG configurations.

Aspect 47: The method of Aspect 45, wherein the CG period satisfies the period condition based on being a shortest CG period of a plurality of CG periods associated with the plurality of CG configurations.

Aspect 48: The method of any of Aspects 44-47, wherein the selected CG configuration is associated with a CG period satisfying a CG identifier condition.

Aspect 49: The method of Aspect 48, wherein the CG period satisfies the CG identifier condition based on being a highest CG identifier value of a plurality of CG identifier values associated with the plurality of CG configurations.

Aspect 50: The method of any of Aspects 48-49, wherein the CG period satisfies the CG identifier condition based on being a lowest CG identifier value of a plurality of CG identifier values associated with the plurality of CG configurations.

Aspect 51: The method of any of Aspects 35-37, wherein the at least one UTO parameter comprises a UTO offset parameter associated with the plurality of CG configurations, wherein the configuration information omits a configuration of the UTO offset parameter, and wherein, based on the configuration information omitting the configuration of the UTO offset parameter, the UTO offset parameter is based on a specified value.

Aspect 52: The method of any of Aspects 35-37, wherein the UTO-UCI indication is associated with a UTO periodicity comprising a plurality of UTO periods.

Aspect 53: The method of Aspect 52, wherein the UTO periodicity comprises a fixed-window periodicity.

Aspect 54: The method of either of claims 52 or 53, wherein the configuration information indicates a starting time of a first UTO period of the plurality of UTO periods, and wherein at least one additional starting time of at least one additional UTO period of the plurality of UTO periods is based on the first UTO period.

Aspect 55: The method of any of Aspects 52-54, wherein a starting time of a first UTO period of the plurality of UTO periods corresponds to a starting time of a first CG period of a first CG configuration of the plurality of CG configurations, and wherein at least one additional starting time of at least one additional UTO period of the plurality of UTO periods is based on the first UTO period.

Aspect 56: The method of Aspect 55, wherein the UTO-UCI indication is associated with a single CG configuration, and wherein the first CG configuration comprises the single CG configuration.

Aspect 57: The method of Aspect 55, wherein the UTO-UCI indication is associated with the plurality of CG configurations, and wherein the first CG configuration comprises a selected CG configuration of the plurality of CG configurations.

Aspect 58: The method of Aspect 57, wherein the selected CG configuration is associated with a CG period satisfying a period condition.

Aspect 59: The method of Aspect 58, wherein the CG period satisfies the period condition based on being a longest CG period of a plurality of CG periods associated with the plurality of CG configurations.

Aspect 60: The method of Aspect 58, wherein the CG period satisfies the period condition based on being a shortest CG period of a plurality of CG periods associated with the plurality of CG configurations.

Aspect 61: The method of Aspect 57, wherein the selected CG configuration is associated with a CG period satisfying a CG identifier condition.

Aspect 62: The method of Aspect 61, wherein the CG period satisfies the CG identifier condition based on being a highest CG identifier value of a plurality of CG identifier values associated with the plurality of CG configurations.

Aspect 63: The method of Aspect 61, wherein the CG period satisfies the CG identifier condition based on being a lowest CG identifier value of a plurality of CG identifier values associated with the plurality of CG configurations.

Aspect 64: The method of Aspect 57, wherein the configuration information indicates the selected CG configuration.

Aspect 65: The method of any of Aspects 52-64, wherein the UTO periodicity comprises a floating window periodicity.

Aspect 66: The method of any of Aspects 52-65, wherein a starting time of a first UTO period of the plurality of UTO periods corresponds to a UTO offset from an ending time of a transmitted CG physical uplink shared channel.

Aspect 67: The method of any of Aspects 52-66, wherein receiving the UTO-UCI comprises receiving the UTO-UCI in a first CG physical uplink shared channel (PUSCH) occasion occurring prior to a UTO offset that starts from an end of a second CG PUSCH occasion in a UTO period, and wherein a length of the UTO-UCI is based on a transmitted time occasion associated with the first CG PUSCH occasion.

Aspect 68: An apparatus for wireless communication at a device, comprising a processor; memory coupled with the processor; and instructions stored in the memory and executable by the processor to cause the apparatus to perform the method of one or more of Aspects 1-34.

Aspect 69: A device for wireless communication, comprising a memory and one or more processors coupled to the memory, the one or more processors configured to perform the method of one or more of Aspects 1-34.

Aspect 70: An apparatus for wireless communication, comprising at least one means for performing the method of one or more of Aspects 1-34.

Aspect 71: A non-transitory computer-readable medium storing code for wireless communication, the code comprising instructions executable by a processor to perform the method of one or more of Aspects 1-34.

Aspect 72: A non-transitory computer-readable medium storing a set of instructions for wireless communication, the set of instructions comprising one or more instructions that, when executed by one or more processors of a device, cause the device to perform the method of one or more of Aspects 1-34.

Aspect 73: An apparatus for wireless communication at a device, comprising a processor; memory coupled with the processor; and instructions stored in the memory and executable by the processor to cause the apparatus to perform the method of one or more of Aspects 35-67.

Aspect 74: A device for wireless communication, comprising a memory and one or more processors coupled to the memory, the one or more processors configured to perform the method of one or more of Aspects 35-67.

Aspect 75: An apparatus for wireless communication, comprising at least one means for performing the method of one or more of Aspects 35-67.

Aspect 71: A non-transitory computer-readable medium storing code for wireless communication, the code comprising instructions executable by a processor to perform the method of one or more of Aspects 35-67.

Aspect 72: A non-transitory computer-readable medium storing a set of instructions for wireless communication, the set of instructions comprising one or more instructions that, when executed by one or more processors of a device, cause the device to perform the method of one or more of Aspects 35-67.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories and configured to cause the UE to:
receive configuration information indicative of a plurality of configured grant (CG) configurations associated with at least one unused time occasion (UTO); and
transmit a UTO-uplink control information (UCI) (UTO-UCI) indication comprising at least one UTO parameter indicative of at least one skipped CG occasion associated with at least one CG configuration of the plurality of CG configurations.

2. The UE of claim 1, wherein the at least one UTO parameter comprises at least one of a UTO period parameter or a UTO offset parameter.

3. The UE of claim 2, wherein the configuration information indicates the at least one of the UTO period parameter or the UTO offset parameter.

4. The UE of claim 1, wherein the at least one UTO parameter comprises a UTO period parameter and a UTO offset parameter, and wherein the UTO period parameter is configured common to the plurality of CG configurations and the UTO offset parameter is configured common to the plurality of CG configurations.

5. The UE of claim 1, wherein the at least one UTO parameter comprises a plurality of UTO period parameters and a plurality of UTO offset parameters, wherein each UTO period parameter of the plurality of UTO period parameters is associated with a respective CG configuration of the plurality of CG configurations, and wherein each UTO offset parameter of the plurality of UTO offset parameters is associated with a respective CG configuration of the plurality of CG configurations.

6. The UE of claim 1, wherein the at least one UTO parameter comprises a UTO period parameter and a plurality of UTO offset parameters, wherein the UTO period parameter is configured common to the plurality of CG configurations, and wherein each UTO offset parameter of the plurality of UTO offset parameters is associated with a respective CG configuration of the plurality of CG configurations.

7. The UE of claim 1, wherein the at least one UTO parameter comprises a plurality of UTO period parameters and a UTO offset parameter, wherein each UTO period parameter of the plurality of UTO period parameters is associated with a respective CG configuration of the plurality of CG configurations, and wherein the UTO offset parameter is configured common to the plurality of CG configurations.

8. The UE of claim 1, wherein the at least one UTO parameter comprises a UTO period parameter, and wherein the UTO period parameter is based on a CG period associated with a CG configuration of the plurality of CG configurations.

9. The UE of claim 8, wherein the at least one UTO parameter comprises at least one additional UTO period parameter, and wherein each additional UTO period parameter of the at least one additional UTO period parameter is based on a respective additional CG period associated with a respective additional CG configuration of the plurality of CG configurations.

10. The UE of claim 1, wherein the at least one UTO parameter comprises a UTO period parameter associated with the plurality of CG configurations, wherein the configuration information omits a configuration of the UTO period parameter, and wherein, based on the configuration information omitting the configuration of the UTO period parameter, the UTO period parameter is based on a selected CG configuration of the plurality of CG configurations.

11. The UE of claim 10, wherein the selected CG configuration is associated with a CG period satisfying a period condition.

12. The UE of claim 11, wherein the CG period satisfies the period condition based on being a longest CG period of a plurality of CG periods associated with the plurality of CG configurations.

13. The UE of claim 11, wherein the CG period satisfies the period condition based on being a shortest CG period of a plurality of CG periods associated with the plurality of CG configurations.

14. The UE of claim 10, wherein the selected CG configuration is associated with a CG period satisfying a CG identifier condition.

15. The UE of claim 14, wherein the CG period satisfies the CG identifier condition based on being a highest CG identifier value of a plurality of CG identifier values associated with the plurality of CG configurations.

16. The UE of claim 14, wherein the CG period satisfies the CG identifier condition based on being a lowest CG identifier value of a plurality of CG identifier values associated with the plurality of CG configurations.

17. The UE of claim 1, wherein the at least one UTO parameter comprises a UTO offset parameter associated with the plurality of CG configurations, wherein the configuration information omits a configuration of the UTO offset parameter, and wherein, based on the configuration information omitting the configuration of the UTO offset parameter, the UTO offset parameter is based on a specified value.

18. The UE of claim 1, wherein the UTO-UCI indication is associated with a UTO periodicity comprising a plurality of UTO periods.

19. The UE of claim 18, wherein the UTO periodicity comprises a fixed-window periodicity.

20.-34. (canceled)

35. A network node for wireless communication, comprising:
one or more memories; and
one or more processors coupled to the one or more memories and configured to cause the network node to:
transmit configuration information indicative of a plurality of configured grant (CG) configurations associated with at least one unused time occasion (UTO); and
receive a UTO-uplink control information (UCI) (UTO-UCI) indication comprising at least one UTO parameter indicative of at least one skipped CG occasion associated with at least one CG configuration of the plurality of CG configurations.

36.-75. (canceled)
